(19) United States
(12) Patent Application Publication
(10) Pub. No.: US 2012/0089429 A1
(43) Pub. Date: Apr. 12, 2012

(54) SYSTEMS AND METHODS FOR GATHERING AND ANALYZING SOCIAL MEDIA DATA

(75) Inventors: Christopher Geddes, London (GB); Bart Schoonbaert, London (GB); Jason Warnke, Tampa, FL (US); Mary Hamilton, San Francisco, CA (US); Scott McGuiney, Toronto (CA); Selvakumar Rajendran, Chennai (IN); Aaron Perryman, Sneads Ferry, NC (US); Ryuhei Mianmi, Tokyo (JP)

(73) Assignee: ACCENTURE GLOBAL SERVICES LIMITED.

(21) Appl. No.: 13/106,626

(22) Filed: May 12, 2011

Related U.S. Application Data
(60) Provisional application No. 61/334,430, filed on May 13, 2010.

(51) Int. Cl. G06Q 10/06

(52) U.S. Cl. 705/7.11

(57) ABSTRACT

Systems and methods are provided for gathering and analyzing social media data, business platform data, and/or gatekeeper data. Priorities are assigned to a plurality of strategic outcomes and business platforms. Scores and recommendations associated with the plurality of strategic outcomes and business platforms are generated.

### TECHNICAL FIELD

This disclosure is directed to systems and methods for utilizing social media, and more particularly, to systems and methods for gathering and analyzing social media data, business platform data and/or analyzing gatekeepers.

### BACKGROUND

Social media is any medium through which a conversation can take place, such as through the internet, telephone, face-to-face, letters, etc. The power of social media has increased exponentially since social media websites have allowed people to converse with, literally, millions of people simultaneously and with minimal effort. The increased presence of social media websites has resulted in an exponential increase in social media usage, and therefore, companies may wish to utilize various social media as effective channels for engaging their customers.

Accordingly, it is desirable to provide systems and methods to gather and analyze social media data, business platform data, and/or gatekeeper data to assist companies in improving the effective usage of the various social media channels for a variety of business platforms.

### SUMMARY

In one embodiment, a computer-implemented method is provided for analyzing social media data, business platform data, and/or gatekeeper data for an entity. The method may include receiving, in a computer system, a set of rankings for a plurality of strategic outcomes and a set of ratings associated with the ability of a plurality of social media channels to affect the strategic outcomes. The method may also include receiving, in the computer system, a set of rankings for a plurality of business platforms and a set of ratings associated with the ability of the plurality of social media channels to affect the business platforms. The method may also include receiving, in the computer system, a set of ratings associated with the ability of the business platforms to affect the strategic outcomes and the ranking of the strategic outcomes. The method may also include receiving, in a computer system, a set of assessments for the entity's current engagement over the social media channels. The method may also include receiving, in a computer system, a set of assessments for met and/or unmet gatekeepers. The sets of rankings, ratings, and assessments may be stored in the repository of the computer.

The method may include generating, using the computer system, a set of first Social Media Channel (SMC) scores based on rankings of the strategic outcomes and the ratings associated with the ability of the social media channels to affect the strategic outcomes. The method may include generating, using the computer system, a set of second SMC scores associated with the rankings of the strategic outcomes and a plurality of the ratings associated with the ability of the social media channels to affect the strategic outcomes (i.e. associated with the first SMC scores). The method may also include prioritizing the social media channels according to the second SMC scores.

The method may further include generating a set of third SMC scores associated with the ability of the social media channels to affect the business platforms. The method may include generating a set of overall SMC scores associated with the rankings of the strategic outcomes and a plurality of the ratings associated with the ability of the social media channels to affect the strategic outcomes (i.e. the second SMC scores) and the ratings associated with the ability of the social media channels to affect the business platforms (i.e. the third SMC scores). The method may include prioritizing the social media channels according to the overall SMC scores.

The method may include generating, using the computer system, a set of first Business Platform (BP) scores associated with the ratings of the ability of the business platforms to be affected by the social media channels. The method may include generating, using the computer system, a set of second BP scores associated with the ratings of the ability of the business platforms to affect the strategic outcomes and the ranking of the strategic outcomes. The method may also include generating, using the computer system, a set of overall business platform scores associated with the rankings of the business platforms, the first BP scores, and the second BP scores. The method may also prioritize the business platforms according to the overall business platform scores.

The method may also include receiving, in the computer system, a set of assessments associated with met or unmet criteria, also called gatekeepers.

The method may also include assessing a current level of engagement by the entity over a social media channel, and determining whether the entity is ready to proceed to a different level of engagement over the social media channel, which may be based on the second SMC scores, the overall social media channel scores, the overall business platform scores, and/or the assessments of the gatekeepers.

It is to be understood that both the foregoing description and the following description are exemplary and explanatory only and are not restrictive of the invention, as claimed.

The accompanying drawings, which are incorporated in and constitute a part of this specification, illustrate exemplary embodiments of the disclosure and together with the description, serve to explain the principles of the disclosure.

### BRIEF DESCRIPTION OF THE DRAWINGS

FIG. 1 is a block diagram illustrating an exemplary embodiment of a system for gathering and analyzing social media data;

FIG. 2 illustrates an exemplary embodiment of a worksheet that may be utilized by a diagnostic tool of the system of FIG. 1;

FIG. 3 illustrates an exemplary embodiment of another worksheet that may be utilized by a diagnostic tool of the system of FIG. 1;

FIG. 4 illustrates an exemplary embodiment of a spider chart that may be generated by the system of FIG. 1;

FIG. 5 illustrates an exemplary embodiment of a table that may be utilized by a diagnostic tool of the system of FIG. 1;

FIG. 6 illustrates an exemplary process for analyzing social media data; and

FIG. 7 illustrates an exemplary computing system suitable for implementing embodiments consistent with the disclosure.

### DETAILED DESCRIPTION

Reference will now be made in detail to the present exemplary embodiments consistent with the disclosure, examples of which are illustrated in the accompanying drawings. Wherever convenient, the same reference numbers will be used throughout the drawings to refer to the same or like parts.

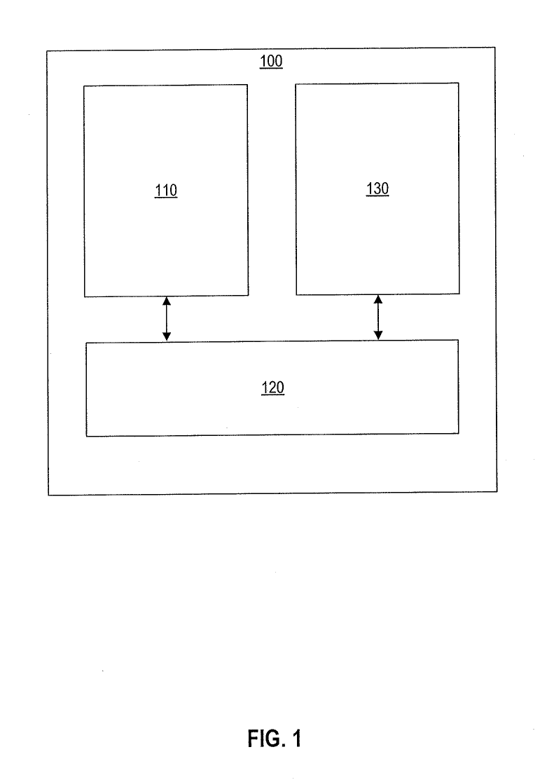

FIG. 1 illustrates an exemplary system 100 that may be utilized in analyzing social media data related to an entity's usage of various social media channels. In some embodiments, system 100 may include a compiling tool 110, one or more repositories 120, and a diagnostic tool 130. It is contemplated that system 100 may include more or fewer components, if appropriate and/or necessary. For example, a system with a memory and a processor configured to perform the functions of the compiling tool, the diagnostic tool, and serve as a repository would be an appropriate system; a separate repository is not necessary.

In some embodiments, compiling tool 110 may assist a user in gathering social media usage data. In some embodiments, compiling tool 110 may assist a user in gathering information regarding an entity's needs with respect to utilizing social media. For example, compiling tool 110 may receive inputs relating to (1) an entity's strategic outcome rankings (e.g., the entity's priorities of strategic outcomes, such as cost effectiveness, revenue management, customer satisfaction, demand management, etc.), (2) an entity's business platform rankings (e.g., the entity's priorities of business platforms, such as platforms for managing retail strategy, managing customer interactions, managing operations and services, managing supply, managing field operations requests, managing data and insight, customer advocacy, monitoring performance, managing compliance, managing quality and performance, and/or managing third party interactions, etc.), (3) a plurality of ratings associated with the strategic outcomes and the plurality of social media channels (e.g., a blog, an open micro-blog, a closed micro-blog, an open social network, a closed social network, a commentable user-generated content, a discussion forum, a crowdsourcing/Wikis site, optimization of search engine, and/or mobile media, etc.), (4) a plurality of ratings associated with the social media channels and the plurality of business platforms, (5) a plurality of ratings associated with the business platforms and the rankings of the strategic outcomes, and/or (6) a set of assessments associated with the met or unmet gatekeepers. It is contemplated that compiling tool 110 may receive more or fewer inputs, if appropriate and/or necessary.

In some embodiments, an entity's strategic outcome rankings may range from 1 to 4, the entity's business platform rankings may range from 1 to 3, the plurality of ratings associated with the strategic outcomes and the plurality of social media channels may range from 0 to 5, the plurality of ratings associated with the social media channels and the plurality of business platforms may range from 1 to 3, and the plurality of ratings associated with the business platforms and the rankings of the strategic outcomes may range from 1 to 4, or there may be no rating if a business platform does not affect a strategic outcome or minimally affects a strategic outcome.

According to some embodiments, compiling tool 110 may be connected to repositories 120. The inputs received by compiling tool 110 may be stored in repositories 120. The repositories may be distinct components from the compiling tool, or it may be integrated (i.e. the repository may be a separate data storage device, or it may be a memory coupled to a processor and configured to act as both a compiling tool and store the received information). It is contemplated that inputs may be provided by a third party (e.g., a client (customer) of a user using compiling tool 110, or by a user of compiling tool 110, or a combination thereof).

In some embodiments, diagnostic tool 130 may assist a user in analyzing the inputs received by compiling tool 110. According to some embodiments, diagnostic tool 130 may be connected to repositories 120. Diagnostic tool 130 may retrieve the inputs stored in repositories 120. Alternatively, the diagnostic tool and the repository may be integrated, such as a processor coupled to a memory and configured to perform the functions of the diagnostic tool as well as store received information.

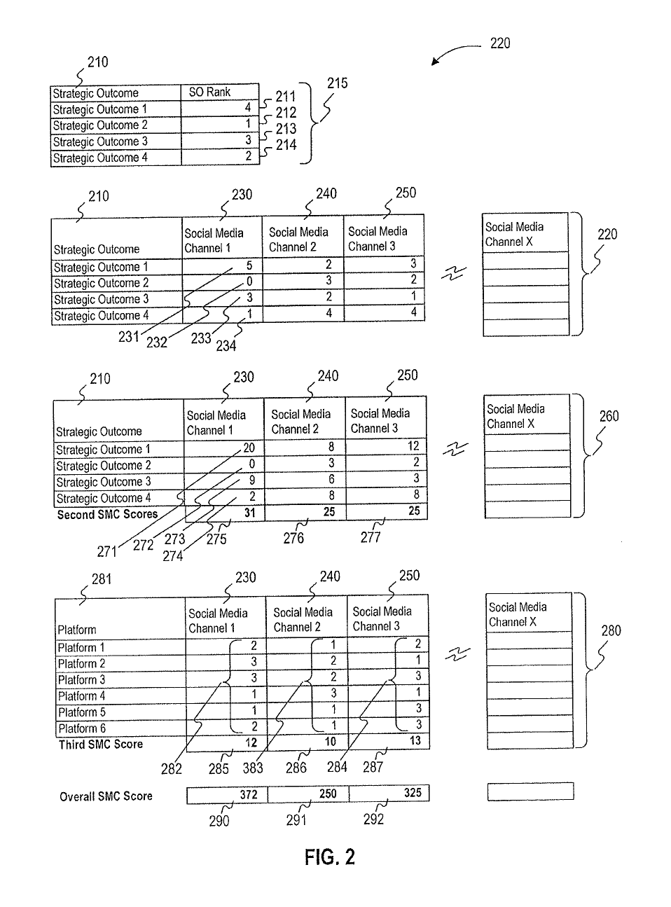

FIG. 2 illustrates a worksheet 200 that may be utilized by diagnostic tool 130 for analyzing the stored inputs. In the embodiment as shown, worksheet 200 includes a table 215, a table 220, and a table 260. Table 215 may include column 210 and fields 211-214. Column 210 of table 215 may include one or more strategic outcomes. In the embodiment as shown, column 210 includes four strategic outcomes. Fields 211-214 may include a ranking of the entity's strategic outcome priorities. In some embodiments, the ranks may be derived based on the priority. For example, the rank may be the same as the assigned priority. In some embodiments, the rank may be an inverse of the assigned priority, such that the lower the priority number, the higher the importance, and the higher the ranking. In some embodiments, the strategic outcomes will be assigned unique rankings. Alternatively, more than one strategic outcome may be assigned the same ranking, such as instances when the strategic outcomes have the same or similar priority. It is contemplated that these or other ranking schemes may be employed, and one of skill in the art will be able to modify the disclosure as appropriate and/or necessary to accommodate the ranking scheme used.

In the embodiment as shown, the rankings range from 1-4, the inverse ranking scheme is used, and each strategic outcome is assigned a unique rank. Thus, strategic outcome 1 is the entity's top priority out of a total of four strategic outcomes, so it is assigned a ranking of 4 (field 211). Likewise, strategic outcome 2 has an assigned priority of 4, the lowest priority, and is assigned a ranking of 1 (field 212), strategic outcome 3 has an assigned priority of 2 and is assigned a ranking of 3 (field 213), and strategic outcome 4 has an assigned priority of 3 and is assigned a ranking 2 (field 214).

Still referring to FIG. 2, in some embodiments, table 220 may include column 210, fields 230-234, 240, and 250. Fields 230, 240, and 250 may represent the various social media channels. In the embodiment as shown, field 230 represents social media channel 1, field 240 represents social media channel 2, and field 250 represents social media channel 3. Table 220 may include a plurality of ratings associated with the social media channels (e.g., fields 230-250) and the strategic outcomes (e.g., column 210). The ratings may represent the ability of use of the social media channels to affect the strategic outcomes. In some embodiments, a higher rating may represent a greater ability of the use of the social media channel to affect a strategic outcome. In some embodiments, a higher rating may represent a lower ability of the use of the social media channel to affect a strategic outcome. In some embodiments, more than one social media channel may be assigned the same rating, such as instances when the social media channels have the same or similar ability to affect a strategic outcome. Alternatively, in some embodiments, the social media channels may be assigned unique ratings. It is contemplated that various rating schemes may be employed, and one of skill in the art would be able to modify the disclosure as appropriate and/or necessary to accommodate the rating scheme used.

In the embodiment as shown, the ratings range from 0-5, higher ratings represent greater ability for use of the social media channel to affect the strategic outcomes, and more than one social media channel may be assigned the same rating. In the embodiment as shown, use of social media channel 1 has the greatest ability to affect strategic outcome 1, so it is assigned a rating of 5 (field 231). The rating associated with social media channel 1 and strategic outcome 2 is 0 (field 232), the rating associated with social media channel 1 and strategic outcome 3 is 3 (field 233), and the rating associated with social media channel 1 and strategic outcome 4 is 1 (field 234).

Table 260 may include column 210, fields 230, 240, 250, and fields 271-277. Table 260 may include a first set of Social Media Channel scores (fields 271-271) associated with the strategic outcomes (e.g., column 210), the social media channels (e.g., fields 230-250), and the ranking of the strategic outcomes (e.g. table 215). In this embodiment, field 271 includes the value of 20, which is the first SMC score associated with social media channel 1 and strategic outcome 1. The SMC score is obtained by multiplying the rank associated with strategic outcome 1 (field 211) by the rating associated with strategic outcome 1 and social media channel 1 (field 231). Similarly, field 272 includes the value of 0, which is the first SMC score for social media channel 1 and strategic outcome 2, and which is obtained by multiplying the rank associated with strategic outcome 2 (field 212) by the rating associated with strategic outcome 2 and social media channel 2 (field 232). Also as shown in this embodiment, field 273 includes the first SMC score of 9, and field 274 includes the first SMC score of 2.

A set of second SMC scores (fields 275-277) is then calculated by adding together the first SMC scores associated with the social media channels. In this embodiment, the second SMC score for social media channel 1 is 31 (field 275), which is obtained by summing the first SMC scores for social media channel 1 (fields 271-274). The rest of table 260 is completed likewise. Field 276 includes the second SMC score for social media channel 2, which is calculated by adding together the first SMC scores in the corresponding fields of table 260 for social media channel 2. Field 277 includes the second SMC score for social media channel 3, which is calculated by adding together the first SMC scores in the corresponding fields of table 260 for social media channel 3.

Table 280 may include column 281, fields 230, 240, 250, and columns 282-287. Table 280 may include a set of ratings (e.g. columns 282-284) associated with the ability of the social media channels (e.g. fields 230-250) to affect the business platforms (e.g. column 281). In this embodiment, columns 282-284 represent the ratings of the ability of social media channel 1 to affect the business platforms 1-6. A set of third SMC scores (fields 285-287) is then calculated by adding together the ratings associated with the social media channels. In this embodiment, the third SMC score for social media channel 1 is 12 (field 285), which is calculated by adding together the ratings in column 282. Likewise, the third SMC score for social media channel 2 is 10 (field 286), which is calculated by adding together the ratings in column 283, and the third SMC score for social media channel 3 is 13 (field 287), which is calculated by adding together the ratings in column 284.

Worksheet 200 may also include overall SMC scores (e.g. fields 290-291). In the embodiment shown, the overall SMC score for social media channel 1 is 372 (field 290), which is calculated by multiplying the second SMC score for social media channel 1 (field 275) by the third SMC score for social media channel 1 (field 285).

It is contemplated that worksheet 200 may include any number of strategic outcomes, any number of social media channels, and/or any number of business platforms.

The second SMC scores and the overall SMC scores, either alone or in combination, may assist a user of system 100 in understanding the importance of a particular social media to a client and the potential impact the particular social media may have on a client's engagement with its customers. For example, the scores included in fields 275-277 and/or 290-292 may be used to recommend the most potent form of social media for the client. In the embodiment as shown, fields 275 and 290 have the highest scores among their respective fields, thus, social media channel 1 may be recommended as a potential social media channel that the client should focus on. In addition, the second SMC scores and the overall SMC scores may assist a user to determine which form of social media should receive less attention.

Furthermore, in some embodiments, the second SMC scores may be used to prioritize social media channels according to their abilities to affect the strategic outcomes and the rankings of those strategic outcomes. According to the embodiment represented in FIG. 2, a higher second SMC score corresponds to a higher priority for the social media channel. Thus, in FIG. 2, social media channel 1 has the highest priority with an second SMC score of 31 (field 275), and social media channels 2 and 3 have the same priority with second SMC scores of 25 (fields 276-277).

Likewise, in some embodiments, the overall SMC scores may be used to prioritize social media channels according to their abilities to affect the strategic outcomes and the rankings of those strategic outcomes, and the ability of the strategic outcomes to affect the business platforms. According to the embodiment represented in FIG. 2, a higher overall SMC score corresponds to a higher priority for the social media channel. Thus, in FIG. 2, social media channel 1 has the highest priority with an overall SMC score of 372 (field 290), social media channel 3 has the next highest priority with an overall SMC score of 325 (field 292), and social media channel 2 has the lowest priority with an overall SMC score of 250 (field 292).

Alternatively, if different ranking and rating schemes were chosen, a lower SMC score may correspond to a higher priority for the social media channel. It is contemplated that one of skill in the art would be able to modify the disclosure as appropriate and/or necessary to accommodate the ranking and/or rating scheme used to generate a set of second SMC scores which can be appropriately prioritized according to the social media channels' abilities to affect the strategic outcomes and the ranks of the strategic outcomes.

In some embodiments, diagnostic tool 130 may include algorithms to calculate the first set of SMC scores (fields 271-274 and corresponding fields in table 260), the second set of SMC scores (fields 275-277), the third set of SMC scores (fields 285-287), and the overall SMC scores (fields 290-292). It is also contemplated that worksheet 200 may be stored in repositories 120. In some embodiments, worksheet 200 may be updated dynamically. For example, worksheet 200 may be updated based on information communicated by compiling tool 110, such that updates received by compiling tool 110 assist in updating worksheet 200.

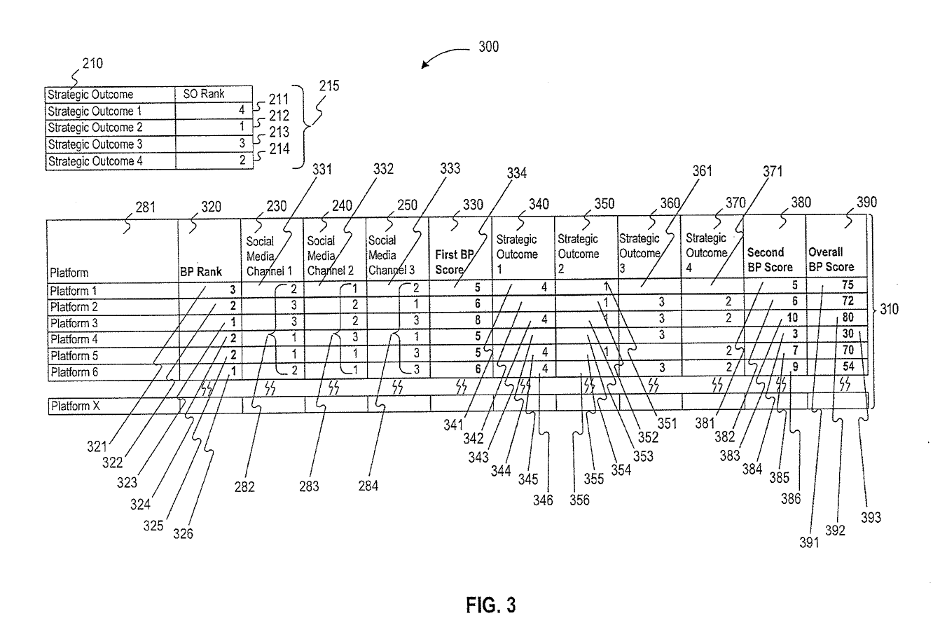

FIG. 3 illustrates a worksheet 300 that may be utilized by diagnostic tool 130 for analyzing the stored inputs. In the embodiment as shown, worksheet 300 includes a table 215 and a table 310. Table 215 may include rankings of strategic outcomes, as described above. Table 310 may include columns 281-284, 320-350, and fields 230-250, 321-326. Column 281 may include one or more business platforms. In the embodiment as shown, column 281 includes six platforms.

Column 320 may include priorities relating to the business platforms assigned by a client. Fields 321-326 may include a ranking of the entity's business platform priorities. In some embodiments, the ranks may be derived based on the priority. For example, the rank may be the same as the assigned priority. In some embodiments, the rank may be an inverse of the assigned priority, such that the lower the priority number, the higher the importance, and the higher the ranking. In some embodiments, the business platforms will be assigned unique rankings. Alternatively, more than one business platform may be assigned the same ranking, such as instances when the business platforms have the same or similar priority. It is contemplated that these or other ranking schemes may be employed, and one of skill in the art will be able to modify the disclosure as appropriate and/or necessary to accommodate the ranking scheme used. In the example as shown, business platform 1 has the highest priority and is assigned a ranking of 3 (field 321). Business platforms 2, 4 and 5 have the next highest priority and are assigned a ranking of 2 (fields 322, 324, and 325). Business platforms 3 and 6 have the lowest priority and are assigned a ranking of 1 (fields 323 and 326).

Still referring to FIG. 3, columns 230-250 and 282-284 may correspond to the same columns from table 260 (referring to FIG. 2) and are as described above. Column 282 may include a plurality of ratings associated with social media channel 1 (field 230) and the business platforms. Column 283 may include a plurality of ratings associated with social media channel 2 (field 240) and the business platforms. Column 284 may include a plurality of ratings associated with social media channel 3 (field 250) and the business platforms.

Column 330 may include a set of first BP scores associated with the plurality of ratings of the ability of the business platform to be affected by the social media channels. In the embodiment as shown, the first BP score for platform 1 is 5 (field 334), which is calculated by adding together the ratings of the ability of business platform 1 to be affected by the social media channels (fields 331-333). Likewise, the first BP scores are calculated for the business platforms 2-6 by adding together the ratings of the ability of the business platforms to be affected by the social media channels in the corresponding fields of table 310.

Columns 340-370 may include a set of ratings associated with the ability of the business platforms to affect the strategic outcomes as well as the ranking of the strategic outcomes. In some embodiments, a separate step may be required to determine whether the various social media channels are able to be affected by the various business platforms may. In some embodiments, the determinations on the ability of the business platforms to affect the strategic outcomes are made at the time the ratings are entered (or receive no rating). In the embodiment as shown, if the business platforms are able to affect the strategic outcomes, the rank assigned to the strategic outcome is assigned to the appropriate field. For example, for column 340 in the embodiment as shown, strategic outcome 1 has the highest priority and is assigned a ranking of 4 (field 211). Business platforms 1, 3, 5, and 6 are able to affect strategic outcome 1, so the corresponding fields are assigned a rating of 4, according to the strategic outcome 1's ranking of 4 (fields 341, 343, 345, and 346). Business platforms 2 and 4 are not able to affect strategic outcome 1, so the corresponding fields are assigned no rating (fields 342 and 344).

Similarly, for column 350 in the embodiment as shown, strategic outcome 2 has the lowest priority and is assigned a ranking of 1 (field 212). Business platforms 1, 2, 3, and 5 are able to affect strategic outcome 2, so the corresponding fields are assigned a rating of 2, according to strategic outcome 2's ranking of 1 (fields 351, 352, 353, and 355). Business platforms 4 and 6 are not able to affect strategic outcome 2, so the corresponding fields are assigned no rating (fields 354 and 356). Likewise, columns 360 and 370 are assigned ratings in the same manner. It is contemplated that these or other ranking and rating schemes, as well as correspondence between those schemes, may be employed, and one of skill in the art will be able to modify the disclosure as appropriate and/or necessary to accommodate the schemes used.

In table 360 of FIG. 3, column 380 may include a set of second BP scores which are based on the ratings associated with the ability of the business platforms to affect the strategic outcomes and the rankings of the strategic outcomes (e.g. columns 340-370). In the embodiment as shown, platform 1 is assigned a second BP score of 5 (field 381), which is calculated by adding together the ratings in fields 341, 351, 361, and 371, and which are associated with the ability of business platform 1 to affect strategic outcomes 1-4 and the rankings of strategic outcomes 1-4. Fields in columns 340-370 that are assigned no rating do not affect the calculation or may be considered to have a rating of 0. Likewise, in the example as shown, the calculations of second BP scores for platforms 2-6 are assigned in fields 382-386. As another example, business platform 2 is assigned a second BP score of 6 (field 382), which is calculated by adding together the ratings in the corresponding fields (i.e. 1+3+2 or 0+1+3+2).

Still referring to FIG. 3, column 390 may include a set of overall BP scores which are based on the ability of the rank of the business platforms, the ability of the business platforms to be affected by the social media channels (i.e. the first BP scores), and the ability of the business platform to affect the strategic outcomes and the rankings of the strategic outcomes (i.e. the second BP scores). In the embodiment as shown, business platform 1 has an overall BP score of 75 (field 391), which is calculated by multiplying business platform 1's BP rank of 3 (field 321) by business platform 1's first BP score of 5 (field 334) and by business platform 1's second BP score of 5 (field 381). In the embodiment as shown, the overall BP scores for business platforms 2-6 are likewise calculated in the corresponding fields of column 390.

The overall BP scores included in column 390 may assist a user of system 100 in understanding the importance of a business platform to a client and the potential impact the particular business platform may have on the effectiveness of a client's usage of social media. For example, the overall BP scores included in column 390 may be used to recommend the business platforms for improving effectiveness of a client's usage of social media. In the embodiment as shown, the score associated with business platform 3 is the highest, thus, platform 3 may be recommended as the platform that the client should focus on, which may help to increase the effectiveness of a client's usage of social media. In addition, the values included in column 390 may assist a user to determine which functionality/business platforms should receive less attention.

In some embodiments, diagnostic tool 130 may include algorithms to calculate the various scores included in tables 220, 260, 280, and 310. It is contemplated that worksheet 300 may be stored in repositories 120. In some embodiments, worksheet 300 may be updated dynamically. For example, worksheet 300 may be updated based on information communicated by compiling tool 110, such that updates received by compiling tool 110 assist in updating worksheet 300.

Furthermore, in some embodiments, the overall BP scores may be used to prioritize business platforms according to their abilities to affect the strategic outcomes, the rankings of those strategic outcomes, the ranking of the business platforms, and the abilities of the business platforms to be affected by social media channels. According to the embodiment represented in FIG. 3, a higher overall BP score corresponds to a higher priority for the business platform. Thus, in FIG. 3, business platform 3 has the highest priority with an overall BP score of 80 (field 392) and business platform 4 has the lowest priority with an overall BP score of 30 (field 393).

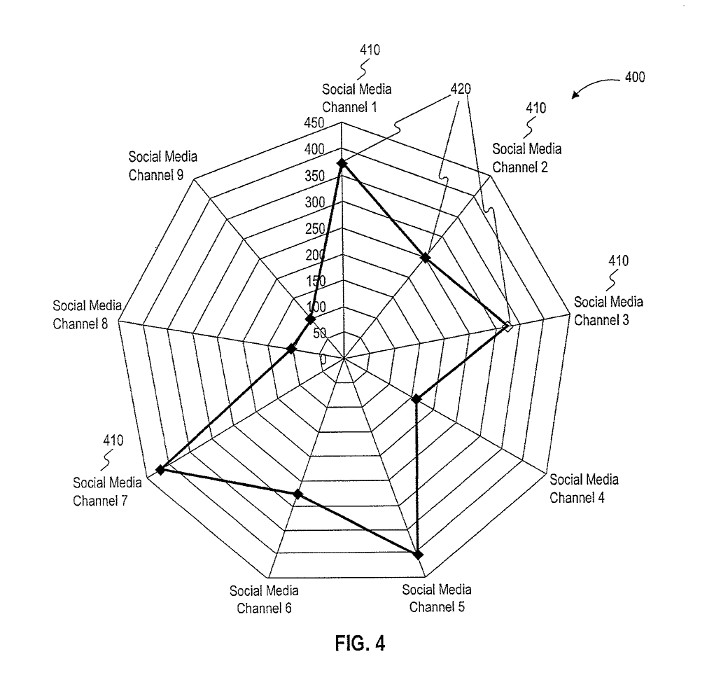

FIG. 4 illustrates an exemplary spider chart 400 that may be generated by diagnostic tool 130. According to some embodiments, spider chart 400 may be stored in repositories 120. In the embodiment as shown, spider chart 400 may include labels 410 and points 420. Labels 410 may indicate a particular social media channel. In the embodiment as shown, points 420 may represent the overall SMC scores in fields 290-292 (referring to FIG. 2). Each value is associated with the various business platforms, the rank associated with a particular social media channel, and the particular social media channel. Spider chart 400 may assist a user using system 100 to more efficiently identify the most beneficial form of social media for the client, i.e., the social media channel(s) the client should focus on. It is contemplated that a similar spider chart may also be generated for recommendations relating to the second SMC scores of the social media channels (fields 275-277 of FIG. 2), and/or the overall BP scores (column 390 of FIG. 3) representing the various business platforms that the client should focus on.

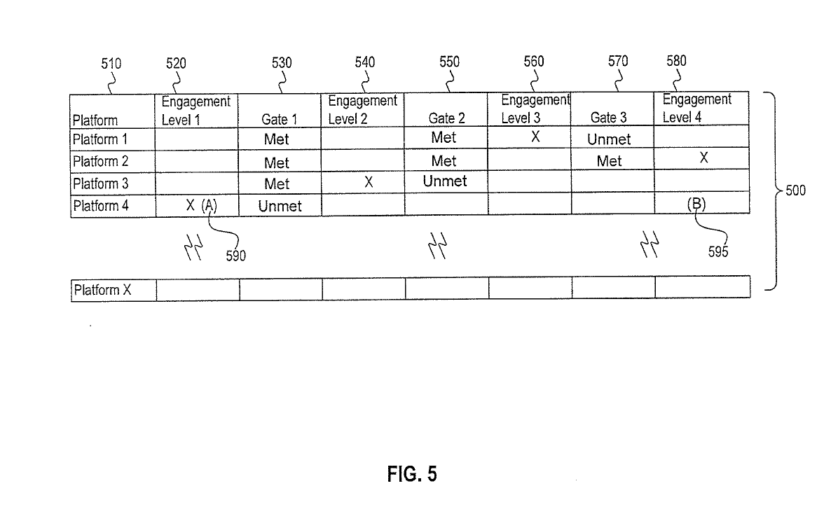

FIG. 5 illustrates a table 500 that may be utilized by diagnostic tool 130 for determining an entity's current level of engagement over a social media channel. In some embodiments, table 500 may also be utilized by diagnostic tool 130 for determining the entity's readiness to move to a different level of engagement over a social media channel. In some embodiments, table 500 may further be utilized by diagnostic tool 130 for determining a desired level of engagement over a social media channel for the entity. It is contemplated that table 500 may be used to determine the level of engagement over one or more social media channels and can be used for the entire entity or for one or more business platforms.

In some embodiments, table 500 may include columns 510-580. In some embodiments, table 500 may include one or more business platforms. In the embodiment as shown, column 510 includes four business platforms and analyzes the engagement level over one social media channel. Columns 520, 540, 560, and 580 may be one or more levels of engagement associated with a social media channel. In the embodiment as shown, table 500 includes four levels of engagement that an entity may have with the social media channel. Columns 530, 550, and 570 may be one or more gatekeepers that a user of diagnostic tool 130 may use to assess entity's current level of engagement over a social media channel, the entity's readiness to move to a different level of engagement over the social media channel, and/or a desired level of engagement over the social media channel for the entity.

For example, these gatekeepers, or criteria, may include (1) cultural alignment, (2) legal education and alignment, (3) marketing and communication alignment, (4) customer facing strategy alignment, (5) tools including software and hardware, (6) website alignment, (7) dedicated resources, (8) organization structure alignment, (9) employee social media training, (10) process alignment, and (11) IT data security. In the embodiment as shown, table 500 includes three different gatekeepers (gates). In the embodiment as shown, the gatekeepers 1 and 2 have been met for business platform 1, indicating that the entity is ready to engage over the social media channel at engagement level 3. However, gatekeeper 3 is unmet, so the entity is not ready to engage over the social media channel at engagement level 4 for business platform 1.

In some embodiments, table 500 may also include a plurality of fields such that a user of diagnostic tool 130 may indicate an entity's level of engagement associated with one or more business platforms over a social media channel. In the embodiment as shown, the entity is assessed to be in a third level of engagement over the social media channel with respect to business platform 1. In addition, the entity is assessed to be in a fourth level of engagement over the social medial channel with respect to business platform 2.

In some embodiments, table 500 may also include indications 590 and 595. Indication 590 may be used to indicate the entity's current level of engagement over a social media channel, for example. Indication 595 may be used to indicate the entity's desired level of engagement over the social media channel. In the embodiment as shown, for business platform 1, the entity is assessed to be in a first level of engagement over the social media channel and that the entity's desired level of engagement is set to be the fourth level. According to some embodiments, one or more columns 530, 550, and 570 may be color coded so that a user of diagnostic tool 130 and/or an entity can quickly identify one or more gatekeepers that have not been satisfied for the entity to proceed to a different level engagement over a social media channel. Similarly, the color coding may also assist the user or the entity to quickly identify one or more gatekeepers that the entity does not need to satisfy, for example.

In some embodiments, results of table 500 may be presented in a chart that is similar to spider chart 400 (referring to FIG. 4), so that a user using system 100 to more efficiently identify one or more functionalities/business platforms and/or one or more gatekeepers the client should focus on. It is contemplated that table 500 may be stored in repositories 120. In some embodiments, table 500 may be updated dynamically. For example, table 500 may be updated based on information communicated by compiling tool 110, such that updates received by compiling tool 110 assist in updating table 500.

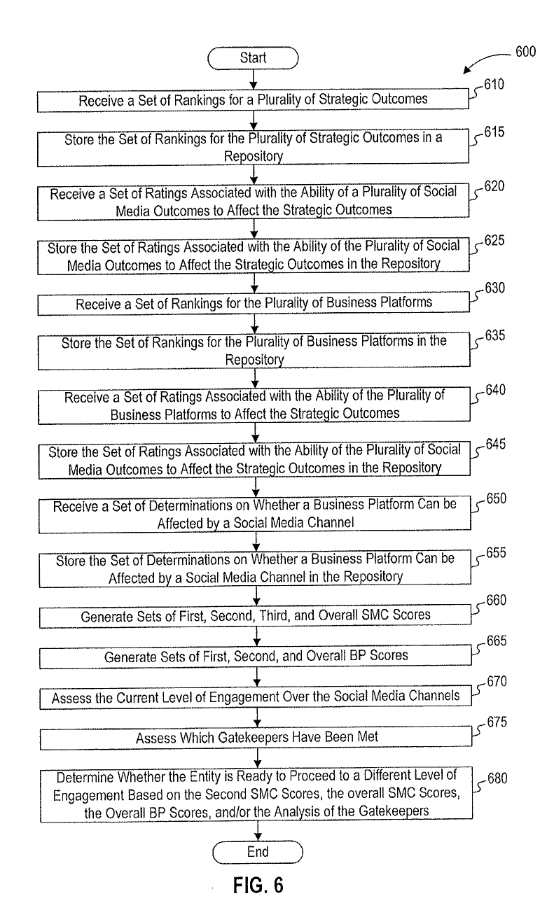

FIG. 6 illustrates an exemplary process 600 for gathering and analyzing social media data, business platform data, and gatekeeper data. In the embodiment as shown, at stage 610, process 600 receives a set of rankings for a plurality of strategic outcomes. In some embodiments, the plurality of strategic outcomes may be cost effectiveness, revenue management, customer satisfaction, demand management, etc. It is contemplated that the plurality of strategic outcomes may include more or fewer strategic outcomes, if appropriate and/or necessary. At stage 615, process 600 may store the set of strategic outcome rankings in repository 120. At stage 620, process 600 receives a set of ratings associated with the ability of a plurality of social media outcomes to affect the strategic outcomes. At stage 625, process 600 may store the set of ratings associated with the ability of a plurality of social media outcomes to affect the strategic outcomes in repository 120.

At stage 630, process 600 may receive a set of rankings for a plurality of business platforms. In some embodiments, the plurality of business platforms may include platforms for managing retail strategy, managing customer interactions, managing operations and services, managing supply, managing field operations requests, managing data and insight, customer advocacy, monitoring performance, managing compliance, managing quality and performance, and/or managing third party interactions, etc. It is contemplated that the plurality of business platforms may include more or fewer business platforms, if appropriate and/or necessary. In some embodiments, the plurality of business platforms may be included in a High Performance Utility Model (HPUM). At stage 635, process 600 may store the set of rankings for the business platforms in repository 120. At stage 640, process 600 may receive a set of ratings associated with the ability of the plurality of social media outcomes to affect the strategic outcomes in repository 120. At stage 645, process 600 may store the set of ratings associated with the ability of the plurality of social media outcomes to affect the strategic outcomes in repository 120.

At stage 650, process 600 may receive a set of determinations on whether a business platform can be affected by a social media channel. At stage 655, process 600 may store the set of determinations on whether a business platform can be affected by a social media channel in repository 120.

At stage 660, process 600 may generate sets of first, second, third, and overall SMC scores. At stage 665, process 600 may generate sets of first second and overall BP scores.

At stage 670, process 600 may assess the entity's current level of engagement over the social media channels. In some embodiments, there may be several levels of engagement over a social media channel. In some embodiments, these levels of engagement may include denial (e.g., denying that social media exists and/or has an impact on a company's market position, etc.), acknowledgement (e.g., recognizing that social media exist, but failing to utilize social media as an available channel of engagement with customers), listen (e.g., monitoring activities occurring over social media channels), participate (e.g., interacting with and/or responding customers over social media channels), instigate (e.g., initiate interactions with customers over social media channels), and host (e.g., establishing and/or sponsoring an environment to enable interactions with customers over social media channels). It is contemplated that the assessment of engagement over a social media channel may be a more general assessment of the entity's engagement as a whole, or it may be a more targeted assessment of the entity's engagement over one or more social media channels for one or more business platforms.

In some embodiments, the social media channel may be a blog (e.g., a website where a person or an organization's opinions on a topic may be displayed and where others may be allowed to comment on such opinions), an open micro-blog (e.g., a website where short comments may be posted and the short comments may be available to all members of the website), a closed micro-blog (e.g., a website where short comments may be posted and the short comments may not be available to all members of the website), an open social network (e.g., a website where a user may post information regarding himself and other members of the website may access the user's information without restrictions), and/or a closed social network (e.g., a website where a user may post information regarding himself and other members of the website may access the user's information only if access is permitted by the user).

In some embodiments, the social media channel may be a commentable user-generated content site (e.g., a website where pieces of content, such as videos, audio files, and/or text may be posted, commented and/or rated by members of the website), a discussion forum (e.g., an environment that facilitates communications and discussion regarding one or more topics between members of the environment), a crowdsourcing/Wikis site (e.g., a website that may be run by a company looking to receive user (customer) input regarding new ideas and/or initiatives, the company may facilitate a platform on which users (customers) may comment and/or rate the ideas and/or propose other ideas, and the company may act upon an idea based on inputs received from users (customers)), optimization of a company's search engine listing (e.g., a search engine may organize presentation of search results according to the most applicable to the least, and a company may promote its listing on the search results through search engine optimization), and/or mobile media (e.g., media associated with a cellular phone, for example, mobile applications that facilitate the cellular phone, PDA (personal digital assistant), or other hand-held device to perform functions the device would otherwise not have the capacity to execute as easily).

For example, it may be assessed that an entity's current level of engagement over a blog is denial, i.e., the entity does not recognize that a blog is a channel through which it may interact with customers. For another example, it may be assessed that an entity's current level of engagement over a discussion forum is participate, i.e., the entity interacts with customers in the discussion forum.

At stage 675, process 600 may assess which gatekeepers have been met. For example, these gatekeepers may include (1) cultural alignment (e.g., whether the entity is culturally aligned with a given social media channel), (2) legal education and alignment (e.g., whether the entity is legally aligned with a given social media channel, such as having policies and guidelines in place to mitigate potential risks of engagement over the given social media channel), (3) marketing and communication alignment (e.g., whether the entity's marketing personnel has been alerted of the potential engagement over the given social media, such that consistency of messages sent over the given social media can be maintained), (4) customer facing strategy alignment (e.g., whether engagement over a given social media channel is aligned with the customer relationship management strategy), (5) tools including software and hardware (e.g., whether the entity has obtained and/or is in a position to obtain the necessary tools for engagement over a given social media channel), (6) website alignment (e.g., whether the entity's website allows for engagement over a given social media channel), (7) dedicated resources (e.g., whether the entity has dedicated personnel for engagement over a given social media channel), (8) organization structure alignment (e.g., whether the entity has the organization structure that allows for an efficient engagement over a given social media channel), (9) employee social media training (e.g., whether the entity has provided and/or is in a position to provide training to employees as to what should be and what should not be engaged over a given social media channel), (10) process alignment (e.g., whether the entity has processes in place that would ensure action items resulting from engagement over a given social media channel to be completely in a timely fashion), and (11) IT data security (e.g., whether the entity can avoid the potential security risks resulting from engagement over a given social media channel). Process 600 may utilize more or fewer gatekeepers, if appropriate and/or necessary. In some embodiments, the gatekeepers may be determined by a user of system 100, by a client or the user, or a combination thereof.

At stage 680, process 600 may determine whether the entity is ready to proceed to a different level of engagement based on the second SMC scores, the overall SMC scores, the overall BP scores, and/or the analysis of the gatekeepers.

In some embodiments, process 600 may ensure that changes to an entity's current level of engagement over a social media channel are not made before the entity has necessary and/or desired structures, policies, and/or processes in place to proceed to a different level of engagement. In some embodiments, process 600 may provide recommendations, such as one or more steps for the entity to follow, to allow gradual and/or sequential changes from the entity's current level of engagement to a different level of engagement. For example, if process 600 determines that an entity may need to satisfy one or more gatekeepers before the entity may proceed to a different level of engagement over the social media channel, process 600 may provide recommendations regarding how the entity may meet the one or more gatekeepers. In addition, process 600 may identify a priority/ranking associated with the one or more gatekeepers according to an order of importance that the gatekeepers should be met. According to some embodiments, the recommendations may be generated from information provided by the entity, information received by diagnostic tool 130, and/or information generated by diagnostic tool 130.

In some embodiments, a user of system 100 may provide a client recommendations based on the scores relating to one or more business platforms and/or one or more social media channels that the client should focus on in developing. According to some embodiments, an entity's desired level of engagement over a particular social media channel may be determined based on the second SMC scores included in fields 275-277 and/or overall SMC scores included in fields 290-292 (referring to FIG. 2), and the recommendations given by the user of system 100. According to some embodiments, an entity's desired business platform on which to use social media channels may be determined based on the overall BP scores included in column 390. The desired level of engagement over the social media channel may also be determined by utilizing gatekeepers (referring to FIG. 5). It is contemplated that these gatekeepers may or may not be the same as the gatekeepers listed above.

In some embodiments, in addition to providing recommendations to a client, a user of system 100 may assist the client in incorporating the recommendations in the client's existing system such that the client may more efficiently use various social media channels, such as assisting the client in developing new and/or modifying existing social media platforms. In some embodiments, a user of system 100 may assist the client in managing the client's usage of the various social media channels. The user may assist the client in managing the client's relationship with its customers over the various social media channels, for example. The user may also assist the client in ensuring security for the client's engagement with its customers over the various social media channels.

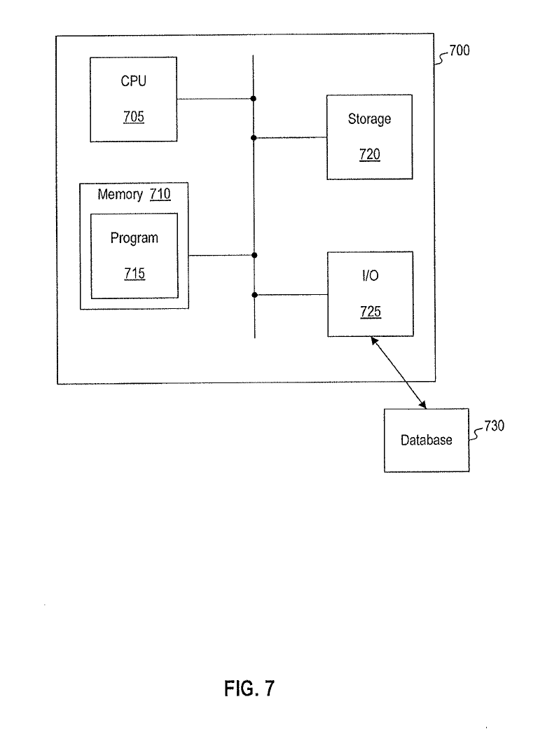

FIG. 7 illustrates an exemplary computing system 700 that may be used to implement embodiments of the disclosure. The components and arrangement, however, may be varied within principles of the present application.

Data processing or computing system 700 includes a number of components, such as a central processing unit (CPU) 705, a memory 710, an input/output (I/O) device(s) 725, a nonvolatile storage device 720, and a database 730. System 700 can be implemented in various ways. For example, an integrated platform (such as a workstation, personal computer, laptop, etc.) may comprise CPU 705, memory 710, nonvolatile storage 720, and I/O devices 725. In such a configuration, components 705, 710, 720, and 725 may connect through a local bus interface and access database 730 (shown implemented as a separate database system) via an external connection. This connection may be implemented through a direct communication link, a local area network (LAN), a wide area network (WAN) and/or other suitable connections. In some embodiments, database 730 may be an embedded database, such that components 705, 710, 720, and 725 may access database 730 through a retrieval library (not shown).

CPU 705 may be one or more known processing devices, such as a microprocessor from the Pentium™ family manufactured by Intel™ or the Turion™ family manufactured by AMD™. Memory 710 may be one or more storage devices configured to store information used by CPU 705 to perform certain functions related to embodiments of the present application. Storage 720 may be a volatile or non-volatile, magnetic, semiconductor, tape, optical, removable, non-removable, or other type of storage device or computer-readable medium. In one embodiment consistent with the disclosure, memory 710 includes one or more programs or subprograms 715 loaded from storage 720 or elsewhere that, when executed by CPU 705, perform various procedures, operations, or processes consistent with the present application. For example, memory 710 may include various exemplary components included in system 100, such as compiling tool 110 and/or diagnostic tool 130. These components may also be embodied in a computer-readable storage memory containing instructions that, when executed by a processor, such as CPU 705, perform methods as described above.

Methods, systems, and articles of manufacture consistent with the present application are not limited to separate programs or computers configured to perform dedicated tasks. For example, memory 710 may be configured with a program 715 that performs several functions when executed by CPU 705. For example, memory 710 may include a single program 715 that performs the functions of compiling tool 110 and/or diagnostic tool 130. Moreover, CPU 705 may execute one or more programs located remotely from system 700. For example, system 700 may access one or more remote programs that, when executed, perform functions related to embodiments of the present application.

Memory 710 may be also be configured with an operating system (not shown) that performs several functions well-known in the art when executed by CPU 705. By way of example, the operating system may be Microsoft Windows™, Unix™, Linux™, an Apple Computers operating system, Personal Digital Assistant operating system such as Microsoft CE™, or other operating system. The choice of operating system, and even the use of an operating system, is not critical to the disclosure.

I/O device(s) 725 may comprise one or more input/output devices that allow data to be received and/or transmitted by system 700. For example, I/O device 725 may include one or more input devices, such as a keyboard, touch screen, mouse, and the like, that enable data to be input from a member, such as concept information, status labels, database identifiers, etc. Further, I/O device 725 may include one or more output devices, such as a display screen, CRT monitor, LCD monitor, plasma display, printer, speaker devices, and the like, that enable data to be output or presented to a member. I/O device 725 may also include one or more digital and/or analog communication input/output devices that allow computing system 700 to communicate with other machines and devices. System 700 may input data from external machines and devices and output data to external machines and devices via I/O device 725. In one embodiment, I/O device 725 may include an interface (not shown) to receive inputs from users of system 100. The configuration and number of input and/or output devices incorporated in I/O device 725 are not critical to the disclosure.

System 700 may also be communicatively connected to a database 730. Database 730 may comprise one or more databases that store information and are accessed and/or managed through system 700. By way of example, database 730 may be an Oracle™ database, a Sybase™ database, a DB2 database, or other relational database. Database 730 may include, for example, one or more repositories 120 that store inputs received by compiling tool 110 and/or various charts generated by diagnostic tool 130. Systems and methods of the present application, however, are not limited to separate databases or even to the use of a database.

Other embodiments of the disclosure will be apparent to those skilled in the art from consideration of the specification and practice of the disclosure disclosed herein. It is intended that the specification and examples be considered as exemplary only, with a true scope and spirit of the disclosure being indicated by the following claims.

What is claimed is:

1. A computer-implemented method of analyzing social media data for an entity, comprising:
receiving a set of Strategic Outcome (SO) rankings for a plurality of strategic outcomes;
receiving a set of Social Media Channel (SMC) ratings for a plurality of social media channels;
generating a set of first SMC scores based on the SO rankings and the SMC ratings; and
generating a set of second SMC scores based on the first SMC scores.

2. The method of claim 1, further comprising:
prioritizing the social media channels according to the second SMC scores;
receiving a current level of engagement of the entity in at least one of the social media channels;
receiving an analysis of a plurality of criteria between the current level of engagement and a different level of engagement; and
generating an indication of the relative advantages of the entity moving from the current level of engagement to the different level of engagement using the second SMC score prioritization and the analysis of the criteria.

3. The method of claim 1, further comprising:
receiving a set of Social Media Channel-Business Platform (SMC-BP) ratings;
generating a set of third SMC scores based on the SMC-BP ratings; and
generating a set of overall SMC scores based on the second SMC scores and the third SMC scores.

4. The method of claim 3, further comprising:
prioritizing the social media channels according to the overall SMC scores;
receiving a current level of engagement of the entity in at least one of the social media channels;
receiving an analysis of a plurality of criteria between the current level of engagement and a different level of engagement;
generating an indication of the relative advantages of the entity moving from one level of engagement using the overall SMC score prioritization and the analysis of the criteria.

5. The method of claim 4, further comprising:
receiving a set of Business Platform (BP) rankings for a plurality of business platforms;
generating a set of first BP scores based on with the SMC-BP of ratings;
receiving a set of BP ratings associated with the SO rankings;
generating a set of second BP scores based on BP ratings;
generating a set of overall BP scores based on the BP rankings, the first BP scores, and the second BP scores;
prioritizing the business platforms according to the overall BP scores;
receiving a current level of engagement of the entity in at least one of the social media channels;
receiving an analysis of a plurality of criteria between the current level of engagement and a different level of engagement; and
determining whether the entity is ready to move to the different level of engagement using the prioritization of overall SMC scores, the prioritization of overall BP scores, and the analysis of the criteria.

6. The method of claim 1, further comprising:
prioritizing the social media channels according to the second SMC scores;
receiving a set of Business Platform (BP) rankings for a plurality of business platforms;
receiving a set of Social Media Channel-Business Platform (SMC-BP) ratings;
generating a set of first BP scores based on with the SMC-BP of ratings;
receiving a set of BP ratings associated with the SO rankings;
generating a set of second BP scores based on BP ratings;
generating a set of overall BP scores based on the BP rankings, the first BP scores, and the second BP scores;
prioritizing the business platforms according to the overall BP scores;
receiving a current level of engagement of the entity in at least one of the social media channels;
receiving an analysis of a plurality of criteria between the current level of engagement and a different level of engagement; and
determining whether the entity is ready to move to the different level of engagement using the prioritization of the second SMC scores, the prioritization of the overall BP scores, and the analysis of the criteria.

7. A computer-implemented method of analyzing business platform data for an entity, comprising:
receiving a set of Business Platform (BP) rankings for a plurality of business platforms;
receiving a set of Social Media Channel-Business Platform (SMC-BP) ratings;
generating a set of first BP scores based on the SMC-BP ratings;
receiving a set of Strategic Outcome (SO) rankings for a plurality of strategic outcomes;
receiving a set of BP ratings associated with the SO rankings;
generating a set of second BP scores based on BP ratings;
generating a set of overall BP scores based on the BP rankings, the first BP scores, and the second BP scores.

8. A system for analyzing social media data for an entity, comprising:
a memory;
and a processor coupled to the memory, the processor being configured to:
receive a set of Strategic Outcome (SO) rankings for a plurality of strategic outcomes;
receive a set of Social Media Channel (SMC) ratings for a plurality of social media channels;
generate a set of first SMC scores based on the SO rankings and the SMC ratings; and
generate a set of second SMC scores based on the first SMC scores.

9. The system of claim 8, the processor further configured to:
prioritize the social media channels according to the second SMC scores;
receive a current level of engagement of the entity in at least one of the social media channels;
receive an analysis of a plurality of criteria between the current level of engagement and a different level of engagement; and
generate an indication of the relative advantages of the entity moving from the current level of engagement to the different level of engagement using the second SMC score prioritization and the analysis of the criteria.

10. The system of claim 8, the processor being further configured to:
receive a set of Social Media Channel-Business Platform (SMC-BP) ratings;
generate a set of third SMC scores based on the SMC-BP ratings; and
generate a set of overall SMC scores based on the second SMC scores and the third SMC scores.

11. The system of claim 10, the processor being further configured to:
prioritize the social media channels according to the overall SMC scores;
receive a current level of engagement of the entity in at least one of the social media channels;
receive an analysis of a plurality of criteria between the current level of engagement and a different level of engagement; and
generate an indication of the relative advantages of the entity moving from one level of engagement using the overall SMC score prioritization and the analysis of the criteria.

12. The system of claim 10, the processor being further configured to:
prioritize the social media channels according to the overall SMC scores;
receive a set of Business Platform (BP) rankings for a plurality of business platforms;
generate a set of first BP scores based on with the SMC-BP of ratings;
receive a set of BP ratings associated with the SO rankings;
generate a set of second BP scores based on BP ratings;
generate a set of overall BP scores based on the BP rankings, the first BP scores, and the second BP scores;
prioritize the business platforms according to the overall BP scores;
receive a current level of engagement of the entity in at least one of the social media channels;
receive an analysis of a plurality of criteria between the current level of engagement and a different level of engagement; and
determine whether the entity is ready to move to the different level of engagement using the prioritization of overall SMC scores, the prioritization of overall BP scores, and the analysis of the criteria.

13. A system for analyzing business platform data for an entity, comprising:
a memory;
and a processor coupled to the memory, the processor being configured to:
receive a set of Business Platform (BP) rankings for a plurality of business platforms;
receive a set of Social Media Channel-Business Platform (SMC-BP) ratings;
generate a set of first BP scores based on the SMC-BP ratings;
receive a set of Strategic Outcome (SO) rankings for a plurality of strategic outcomes;
receive a set of BP ratings associated with the SO rankings;
generate a set of second BP scores based on BP ratings;
generate a set of overall BP scores based on the BP rankings, the first BP scores, and the second BP scores.

14. The system of claim 13, the processor being further configured to:
receive a set of Business Platform (BP) rankings for a plurality of business platforms;
receive a set of Social Media Channel-Business Platform (SMC-BP) ratings;
generate a set of first BP scores based on with the SMC-BP of ratings;
receive a set of BP ratings associated with the SO rankings;
generate a set of second BP scores based on BP ratings;
generate a set of overall BP scores based on the BP rankings, the first BP scores, and the second BP scores;
prioritize the business platforms according to the overall BP scores;
receive a current level of engagement of the entity in at least one of the social media channels;
receive an analysis of a plurality of criteria between the current level of engagement and a different level of engagement; and
determine whether the entity is ready to move to the different level of engagement using the prioritization of the second SMC scores, the prioritization of the overall BP scores, and the analysis of the criteria.

15. A non-transitory computer-readable storage medium containing instructions which, when executed on a processor, perform a method of analyzing social media data for an entity, the method comprising:
receiving a set of Strategic Outcome (SO) rankings for a plurality of strategic outcomes;
receiving a set of Social Media Channel (SMC) ratings for a plurality of social media channels;
generating a set of first SMC scores based on the SO rankings and the SMC ratings; and
generating a set of second SMC scores based on the first SMC scores.

16. The computer-readable storage medium of claim 15, the method further comprising:
prioritizing the social media channels according to the second SMC scores.
receiving a current level of engagement of the entity in at least one of the social media channels;
receiving an analysis of a plurality of criteria between the current level of engagement and a different level of engagement; and
generating an indication of the relative advantages of the entity moving from the current level of engagement to the different level of engagement using the overall SMC score prioritization and the analysis of the criteria.

17. The computer-readable storage medium of claim 15, the method further comprising:
receiving a set of Social Media Channel-Business Platform (SMC-BP) ratings;
generating a set of third SMC scores based on the SMC-BP ratings; and
generating a set of overall SMC scores based on the second SMC scores and the third SMC scores.

18. The computer-readable storage medium of claim 17, the method further comprising:
prioritizing the social media channels according to the overall SMC scores;
receiving a current level of engagement of the entity in at least one of the social media channels;
receiving an analysis of a plurality of criteria between the current level of engagement and a different level of engagement; and
generating an indication of the relative advantages of the entity moving from one level of engagement using the overall SMC score prioritization and the analysis of the criteria.

19. The computer-readable storage medium of claim 17, the method further comprising:
prioritizing the social media channels according to the overall SMC scores;
receiving a set of Business Platform (BP) rankings for a plurality of business platforms;
generating a set of first BP scores based on with the SMC-BP of ratings;
receiving a set of BP ratings associated with the SO rankings;
generating a set of second BP scores based on BP ratings;
generating a set of overall BP scores based on the BP rankings, the first BP scores, and the second BP scores;
prioritizing the business platforms according to the overall BP scores;
receiving a current level of engagement of the entity in at least one of the social media channels;
receiving an analysis of a plurality of criteria between the current level of engagement and a different level of engagement; and
determining whether the entity is ready to move to the different level of engagement using the prioritization of overall SMC scores, the prioritization of overall BP scores, and the analysis of the criteria.

20. The computer-readable storage medium of claim 15, the method further comprising:
prioritizing the social media channels according to the second SMC scores
receiving a set of Business Platform (BP) rankings for a plurality of business platforms;
receiving a set of Social Media Channel-Business Platform (SMC-BP) ratings;
generating a set of first BP scores based on with the SMC-BP of ratings;
receiving a set of BP ratings associated with the SO rankings;
generating a set of second BP scores based on BP ratings;
generating a set of overall BP scores based on the BP rankings, the first BP scores, and the second BP scores;
prioritizing the business platforms according to the overall BP scores;
receiving a current level of engagement of the entity in at least one of the social media channels;
receiving an analysis of a plurality of criteria between the current level of engagement and a different level of engagement; and
determining whether the entity is ready to move to the different level of engagement using the prioritization of the second SMC scores, the prioritization of the overall BP scores, and the analysis of the criteria.

21. A non-transitory computer-readable storage medium containing instructions which, when executed on a processor, perform a method of analyzing business platform data for an entity, comprising:
receiving a set of Business Platform (BP) rankings for a plurality of business platforms;
receiving a set of Social Media Channel-Business Platform (SMC-BP) ratings;
generating a set of first BP scores based on the SMC-BP ratings;
receiving a set of Strategic Outcome (SO) rankings for a plurality of strategic outcomes;
receiving a set of BP ratings associated with the SO rankings;
generating a set of second BP scores based on BP ratings; and
generating a set of overall BP scores based on the BP rankings, the first BP scores, and the second BP scores.
